(19) United States
(12) Patent Application Publication
(10) Pub. No.: US 2022/0120395 A1
(43) Pub. Date: Apr. 21, 2022

(54) LIGHT DISTRIBUTION ELEMENT, LIGHT SOURACE MODULE AND LAMP

(71) Applicants: OPPLE LIGHTING CO., LTD., Shanghai (CN); SUZHOU OPPLE LIGHTING CO., LTD., Suzhou City (CN)

(72) Inventors: Chenxi BU, Suzhou City (CN); Shuchao LI, Suzhou City (CN); Yisheng XIAO, Suzhou City (CN)

(73) Assignees: OPPLE LIGHTING CO., LTD., Shanghai (CN); SUZHOU OPPLE LIGHTING CO., LTD., Suzhou City (CN)

(21) Appl. No.: 17/564,181

(22) Filed: Dec. 28, 2021

Related U.S. Application Data
(63) Continuation of application No. PCT/CN2020/111264, filed on Aug. 26, 2020.

(30) Foreign Application Priority Data
Sep. 23, 2019 (CN) 201910898188.9
Sep. 23, 2019 (CN) 201921581548.4

(51) Int. Cl. F21S 8/02; F21V 5/04; F21V 7/00

(52) U.S. Cl. CPC F21S 8/026; F21Y 2115/10; F21V 7/0016; F21V 5/04

(57) ABSTRACT

Examples of the present disclosure provide a light distribution element, a light source module and a lamp, the light distribution element includes a light entry surface, a first light exit surface and a second light exit surface, the first light exit surface is configured to receive part of light entering the light entry surface and emit the part of the light entering the light entry surface; the second light exit surface is a reflective surface, and the second light exit surface is configured to receive part of the light entering the light entry surface and reflect the part of the light entering the light entry surface; and a direction of the light emitted from the second light exit surface is different from a direction of the light emitted from the first light exit surface, it can be used for key lighting and lighting ceiling areas respectively.

### CROSS-REFERENCE TO RELATED APPLICATIONS

This application is based upon and claims the priority of PCT patent application No. PCT/CN2020/111264 filed on Aug. 26, 2020 which claims priority to the Chinese patent application No. 201910898188.9 filed on Sep. 23, 2019, and Chinese patent application No. 201921581548.4 filed on Sep. 23, 2019, the entire contents of which are hereby incorporated by reference herein for all purposes.

### TECHNICAL FIELD

The present disclosure relates to the technical field of illumination, and particularly to a light distribution element, a light source module and a lamp.

### BACKGROUND

A spot lamp is a lamp for key lighting, which is widely used in homes, shopping malls, hotels and other places. The spot lamp includes a light source and a light distribution element. The light distribution element is generally a reflective cup and/or a lens. The light distribution element enables the light source to have a narrow beam angle, so that the key lighting can be performed, and the light source can be irradiated downward to illuminate a target position.

### SUMMARY

The present disclosure provides a light distribution element, a light source module including the light distribution element and a lamp including the light source module.

According to a first aspect, a light distribution element is provided. The light distribution element may include a light entry surface, a first light exit surface and a second light exit surface, the first light exit surface is configured to receive part of light entering the light entry surface and emit the part of the light entering the light entry surface; the second light exit surface is a reflective surface, and the second light exit surface is configured to receive part of the light entering the light entry surface and reflect the part of the light entering the light entry surface; and a direction of the light emitted from the second light exit surface is different from a direction of the light emitted from the first light exit surface.

According to a second aspect, a light source module is provided. The light source module may include a light source and the light distribution element mentioned above, and the light entry surface is configured to receive light emitted by the light source.

According to a third aspect, a lamp is provided. The lamp may include a shell, a light source and the light distribution element mentioned above, the light entry surface is configured to receive light emitted by the light source, and the light source, the light distribution element and the shell are assembled together.

It is to be understood that both the foregoing general description and the following detailed description are exemplary and explanatory only and are not restrictive of the present disclosure.

### BRIEF DESCRIPTION OF THE DRAWINGS

FIG. 1 is a light path diagram of a light distribution element according to a first example of the present disclosure;

FIG. 2 is a sectional view of the light distribution element according to the first example of the present disclosure;

FIG. 3 is a stereoscopic diagram of the light distribution element according to the first example of the present disclosure;

FIG. 4 is an exploded view of a lamp according to the first example of the present disclosure;

FIG. 5 is a light path diagram of a light distribution element according to a second example of the present disclosure;

FIG. 6 is a top view of a reflector according to the second example of the present disclosure;

FIG. 7 is a stereoscopic diagram of the reflector according to the second example of the present disclosure;

FIG. 8 is a partial enlarged view of a position I in FIG. 7;

FIG. 9 is a reflection schematic diagram of the reflector according to the second example of the present disclosure; and

FIG. 10 is an exploded view of the lamp according to the second example of the present disclosure.

### DETAILED DESCRIPTION

In order to make the purpose, technical solutions, and advantages of the present disclosure clearer, the technical solutions of the present disclosure will be described clearly and completely in conjunction with examples of the present disclosure and the corresponding drawings. Apparently, the described examples are only a part of the examples of the present disclosure, rather than all the examples. Based on the examples in this disclosure, all other examples obtained by those of ordinary skill in the art without creative work shall fall within the protection scope of this disclosure.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Certain spot lamp may mainly emit light downward to illuminate the target position, a ceiling area may be dark, and the illumination comfort of the spot lamp is reduced. In order to improve the illumination comfort, a ceiling lamp or a light strip may be installed on the ceiling at present, the light directivity of the ceiling lamp or the light strip is low, and a small amount of light may be irradiated to the ceiling area, however, the ceiling lamp or the light strip is high in cost, the installation is inconvenient, and there is still the problem that the ceiling area is dark.

### First Example

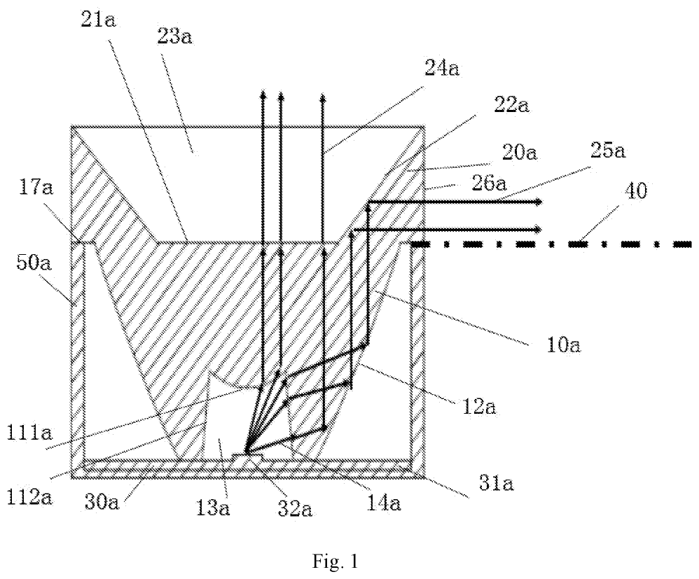

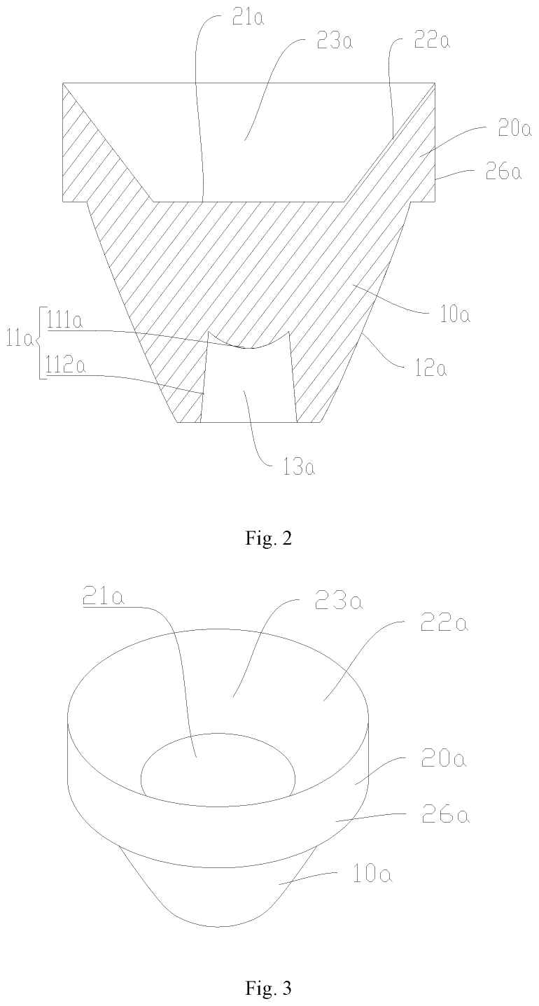

As shown in FIG. 1, the present example discloses a lamp. The lamp includes a light source module. The light source module includes a light source assembly 30a and a light distribution element. The light source assembly 30a includes a light source substrate 31a and a light source 32a, and the light source 32a is mounted on the light source substrate 31a. The light distribution element includes a light entry surface 11a, a first light exit surface 21a and a second light exit surface 22a, and the first light exit surface 21a is configured to receive part of light entering the light entry surface 11a and emit the part of the light entering the light entry surface 11a; the second light exit surface 22a is a reflective surface, and the second light exit surface 22a is configured to receive part of the light entering the light entry surface 11a and reflect the part of the light entering the light entry surface; and a direction of the light emitted from the second light exit surface 22a is different from a direction of the light emitted from the first light exit surface 21a. The light emitted by the light source 32a to the light entry surface 11a is incident light 14a. The light emitted from the first light exit surface 21a is first exited light 24a, and the light reflected by the second light exit surface 22a is second exited light 25a.

The light distribution element of the present example has the advantages that 60% to 80% of the light entering the light entry surface 11a is emitted from the first light exit surface 21a, which can be used for key lighting. 20% to 40% of the light entering the light entry surface 11a is irradiated to the second light exit surface 22a and can be used to illuminate a ceiling 40 after being reflected by the second light exit surface 22a. After the light distribution element of the present example is applied to the lamp, the lamp can illuminate the ceiling 40 area while performing the key lighting, thereby improving the illumination comfort of the whole lamp.

The light distribution element is an integrated collimating lens. Therefore, the light entry surface 11a, the first light exit surface 21a and the second light exit surface 22a all are formed on the collimating lens. Two ends of the collimating lens are an inner end and an outer end respectively, and a distance between the inner end of the collimating lens and the light source substrate 31a is less than a distance between the outer end of the collimating lens and the light source substrate 31a. An inner end surface of the inner end of the collimating lens is recessed inward and encloses a light source cavity 13a, a bottom surface of the light source cavity 13a forms a first light entry surface 111a, and a side surface of the light source cavity 13a forms a second light entry surface 112a. The light entry surface 11a includes the first light entry surface 111a and the second light entry surface 112a.

The light source 32a faces the light source cavity 13a, so that the light can be irradiated to the light source cavity 13a. Preferably, the light source 32a is arranged in the light source cavity 13a, and the inner end surface of the inner end of the collimating lens is butted on the light source substrate 31a, so that the light entry surface 11a and the light source substrate 31a enclose a closed light source cavity 13a, which can not only increase the incident light of the light source 32a entering the light entry surface 11a and improve the light efficiency, but also prevent the light of the light source 32a from being irradiated into the lamp.

Preferably, the light source 32a is arranged at the center of the light source cavity 13a, so that the light emitted by the light source 32a can be irradiated uniformly to the light entry surface 11a, and the uniformity of the first exited light 24a and the second exited light 25a can be improved, thereby further improving the illumination comfort. The light source 32a may be an LED bead, and the number of the LED bead is preferably one. The number of the LED bead may also be multiple.

The end surface of the outer end of the collimating lens is recessed inward to form a light exit cavity 23a, a bottom surface of the light exit cavity 23a is the first light exit surface 21a, and the first exited light 24a is emitted through the light exit cavity 23a. The side surface of the light exit cavity 23a is the second light exit surface 22a, that is, the second light exit surface 22a is formed on the periphery of the first light exit surface 21a. The second light exit surface 22a is inclined outward to the first light exit surface 21a, and a diameter of the light exit cavity 23a increases gradually in a direction towards the outer end surface of the collimating lens. The second exited light 25a does not pass through the light exit cavity 23a, but deviates from the light exit cavity 23a. The first light exit surface 21a and the second light exit surface 22a form a continuous surface, which is conducive to improving the light exit efficiency of the light distribution element.

The collimating lens includes a first main body part 10a and a second main body part 20a; the light source cavity 13a is arranged at the inner end of the first main body part 10a, and the light exit cavity 23a is arranged at the outer end of the second main body part 20a; the outer side surface of the first main body part 10a is a conical surface 12a, and the conical surface 12a inclines outward; and the diameter of the first main body part 10a increases gradually in a direction from the inner end to the outer end.

As shown in FIG. 1, the first light entry surface 111a protrudes towards the inner end surface of the collimating lens; and an irradiating angle range of the light source 32a to the first light entry surface 111a may be 30 degrees to 90 degrees, and the incident light 14a entering the first light entry surface 111a is irradiated to the first light exit surface 21a in a direction perpendicular to the first light exit surface 21a, and continuously emit along the direction perpendicular to the first light exit surface 21a for key lighting, that is, the first exited light 24a is perpendicular to the first light exit surface 21a.

As shown in FIG. 1, the light emitted by the light source 32a outside the first light entry surface 111a is irradiated to the second light entry surface 112a. For example, in a case that an angle of the light emitted by the light source 32a to the first light entry surface 111a is 30 degrees, the remaining light in a total angle of 150 degrees is irradiated to the second light entry surface 112a. In a case that the angle of the light emitted by the light source 32a to the first light entry surface 111a is 90 degrees, the remaining light in a total angle of 90 degrees is irradiated to the second light entry surface 112a. Most of the incident light 14a entering the second light entry surface 112 is irradiated to the conical surface 12a and reflected totally on the conical surface 12a so as to be irradiated to the second light exit surface 22a in a direction of forming an included angle of 45 degrees with the second light exit surface 22a, and then the light is reflected totally on the second light exit surface 22, and further emit in a direction parallel to the ceiling 40. A small part of incident light 14a entering the second light entry surface 112a is irradiated to the conical surface 12a, reflected totally on the conical surface 12 and then irradiated to the first light exit surface 21a in a direction perpendicular to the first light exit surface 21a, and continuously emit along the direction perpendicular to the first light exit surface 21a for key lighting. The second exited light 25a is parallel to the surface of the ceiling 40, which has the advantage that compared with the case where an included angle is formed between the second exited light 25a and the surface of the ceiling 40, the second exited light 25a is parallel to the surface of the ceiling 40, so that a lightened area of the ceiling 40 can be enlarged. The first exited light 24a is perpendicular to the second exited light 25a. Because the ground is parallel to the ceiling 40, the first exited light 24a is irradiated to the ground perpendicularly for key lighting.

The light reflected by the conical surface 12a may be partially irradiated on the first light exit surface 21a, and the other part is irradiated on the second light exit surface 22a. The specific distribution of the light may be realized by changing parameters such as an inclination angle of the conical surface 12a, a position between the first light exit surface 21a and the conical surface 12a, and a position between the second light exit surface 22a and the conical surface 12a.

The outer surface of the second main body part 20a is a cylindrical surface 26a, and the second exited light 25a is irradiated to the cylindrical surface 26a in a direction perpendicular to the cylindrical surface 26a, and then continuously emit in a direction parallel to the ceiling 40.

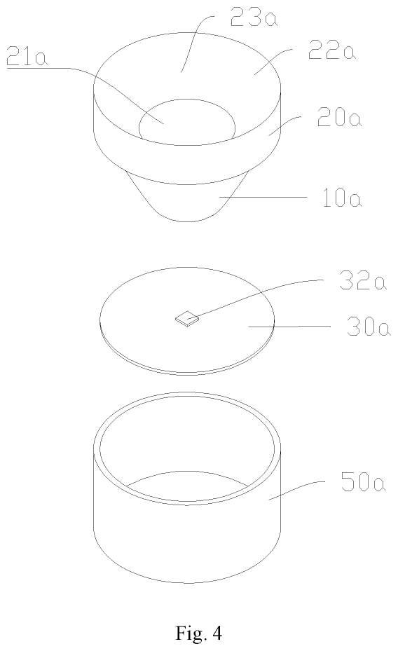

A step surface 17a is formed at a junction of the first main body part 10a and the second main body part 20a. As shown in FIG. 1 and FIG. 4, the lamp also includes a shell 50a, and the shell 50a is mounted in a mounting hole of the ceiling 40. The shell 50a is sleeved on the first main body part 10a. One end of the shell 50a has a bottom plate, and the light source substrate 31a is arranged on the inner surface of the bottom plate of the shell 50a. One end of the shell 50 with the bottom plate is a closed end, and the other end is an open end. The end surface of the open end of the shell 50a is butted on the step surface 17a, and at the time, the second light exit surface 22a is completely exposed outside the shell 50a. As shown in FIG. 1, the second light exit surface 22a extends out of the ceiling 40, so that all of the second exited light 25a can be irradiated to the ceiling 40 area. The shell 50a assembles the light distribution element and the light source assembly 30a of the present example together. The light distribution element and the light source assembly 30a may also be assembled through other structural members.

The above is the preferred solution of the present example, and in other examples, the first exited light 24a may not be perpendicular to the second exited light 25a. The first exited light 24a may also be irradiated to the ground obliquely for key lighting. The second exited light 25a may also be irradiated to the ceiling 40 obliquely. The direction of the first exited light 24a or the direction of the second exited light 25a may be adjusted by changing parameters such as a curvature of the first light entry surface 111a, an inclination angle of the second light entry surface 112a, an inclination angle of the conical surface 12a, an angle of the first light exit surface 21a, an inclination angle of the second light exit surface 22a and the like.

### Second Example

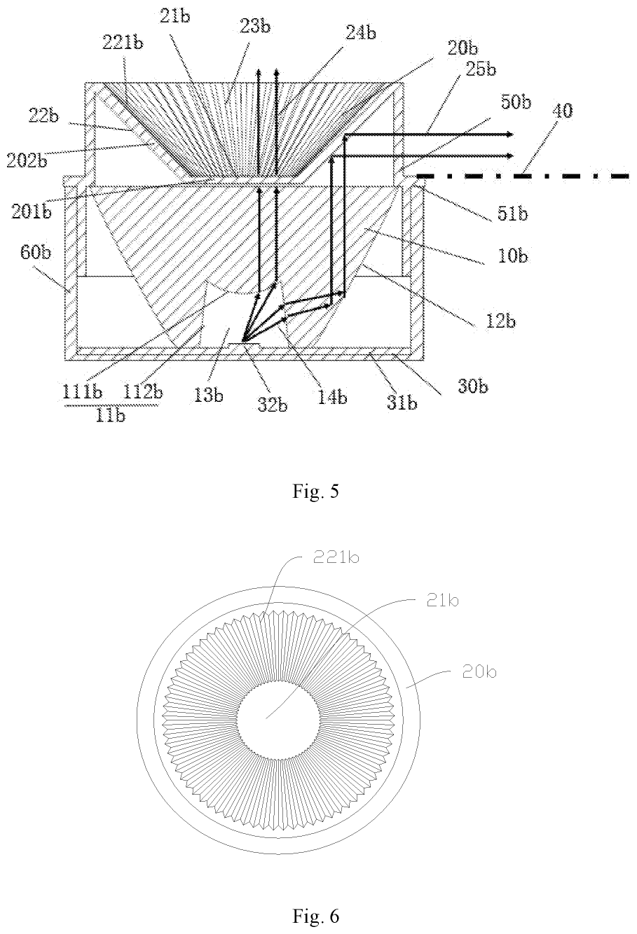

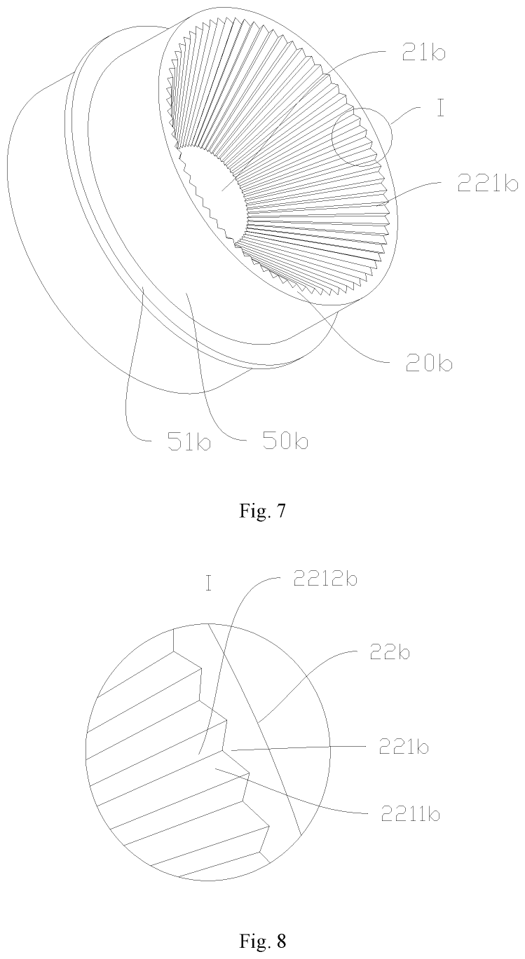

As shown in FIG. 5, the present example discloses a lamp. The lamp includes a light source module. The light source module includes a light source assembly 30b and a light distribution element. The light source assembly 30b includes a light source substrate 31b and a light source 32b, and the light source 32b is mounted on the light source substrate 31b. The light distribution element includes a light entry surface 11b, a first light exit surface 21b and a second light exit surface 22b, and the first light exit surface 21b is configured to receive part of light entering the light entry surface 11b and emit the part of the light entering the light entry surface 11b; the second light exit surface 22b is a reflective surface, and the second light exit surface 22b is configured to receive part of the light entering the light entry surface 11b and reflect the part of the light entering the light entry surface 11b; and the direction of the light emitted from the second light exit surface 22b is different from the direction of the light emitted from the first light exit surface 21b. The light emitted by the light source 32b to the light entry surface 11b is incident light 14b. The light emitted from the first light exit surface 21b is first exited light 24b, and the light emitted from the second light exit surface 22b is second exited light 25b.

The light distribution element of the present example has the advantages that 60% to 80% of the light entering the light entry surface 11b is emitted from the first light exit surface 21b, which can be used for key lighting. 20% to 40% of the light entering the light entry surface 11b is irradiated to the second light exit surface 22b and can be used to illuminate a ceiling 40 after being reflected by the second light exit surface 22b. After the light distribution element of the present example is applied to the lamp, the lamp can illuminate the ceiling 40 area while performing the key lighting, thereby improving the illumination comfort of the whole lamp.

The present example differs from the first example in that the light distribution element of the present example includes a collimating lens 10b and a reflector 20b, and the collimating lens 10b and the reflector 20b are detachably connected. The collimating lens 10b has the advantage that the first exited light 24b and the second exited light 25b are convenient to control, and compared with other light distribution elements, the first exited light 24b can be irradiated to the ground perpendicularly with lower cost, and the second exited light 25b is irradiated to the ceiling 40 area in a direction parallel to the ceiling 40.

A distance between the inner end of the collimating lens 10b and the light source substrate 31b is less than a distance between the outer end of the collimating lens 10b and the light source substrate 31b. The light entry surface 11b is arranged at the inner end of the collimating lens 10b. The reflector 20b is arranged at the outer side of the collimating lens 10b, that is, the reflector 20b is arranged at one side of the collimating lens 10b facing away from the light source 32b. A distance between the inner end of the reflector 20b and the collimating lens 10b is less than a distance between the outer end of the reflector 20b and the collimating lens 10b. The first light exit surface 21b and the second light exit surface 22b are arranged on the reflector 20b.

An inner end surface of the inner end of the collimating lens 10b is recessed inward and encloses a light source cavity 13b, a bottom surface of the light source cavity 13b forms a first light entry surface 111b, and a side surface of the light source cavity 13b forms a second light entry surface 112b. The light entry surface 11b includes the first light entry surface 111b and the second light entry surface 112b.

The light source 32b faces the light source cavity 13b, so that the light can be irradiated to the light source cavity 13b. Preferably, the light source 32b is arranged in the light source cavity 13b, and the inner end surface of the inner end of the collimating lens 10b is butted on the light source substrate 31b, so that the light entry surface 11b and the light source substrate 31b enclose a closed light source cavity 13b, which can not only increase the incident light of the light source 32b entering the light entry surface 11b, but also prevent the light of the light source 32b from being irradiated into the lamp.

The reflector 20b includes a bottom plate 201b and a coaming 202b, the bottom plate 201b and the coaming 202b form a light exit cavity 23b, and the inner surface of the bottom plate 201, that is the bottom surface of the light exit cavity 23b is the first light exit surface 21b. The inner surface of the coaming 202b is provided with sawteeth 221b, and the outer surface of the coaming 202b is a second light exit surface 22b. The first light exit surface 21b and the second light exit surface 22b form a continuous surface, which is conducive to improving the light exit efficiency of the light distribution element. In other examples, the sawteeth 221b may also be formed on the outer surface of the coaming 202b.

The coaming 202b is inclined outward relative to the bottom plate 201b, so that the diameter of the reflector 20b increases gradually in a direction from the inner end to the outer end. The sawteeth 221b are arranged on the inner surface of the coaming 202b along a circumferential direction, and two ends of each sawtooth 221b extend towards two ends of the coaming 202b respectively; and preferably, two ends of each sawtooth 221b extend to the two ends of the coaming 202b, so that the light irradiated on the coaming 202b can be reflected totally, and the totally-reflected light illuminates the ceiling 40 area. The sawtooth 221b includes two connected tooth surfaces, and the two tooth surfaces are a first tooth surface 2211b and a second tooth surface 2212b.

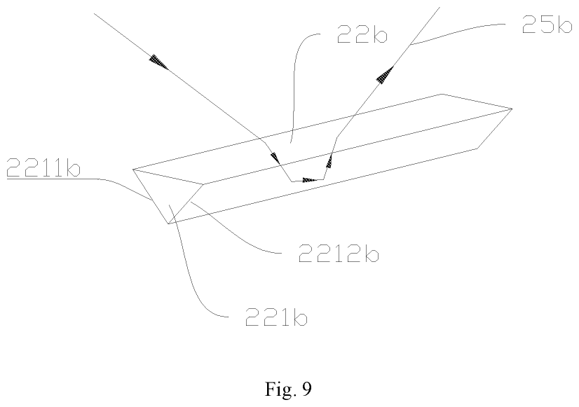

The principle of total reflection by the coaming 202b is as shown in FIG. 9, in a case that the light is irradiated onto the second light exit surface 22b, the light is refracted to enter a first tooth surface 2211b, then the light is reflected totally by the first tooth surface 2211b to the second tooth surface 2212b, then the light is reflected totally by the second tooth surface 2212b to the second light exit surface 22b, the second exited light 25b is refracted from the second light exit surface 22b, and an included angle between the second exited light 25b and the second light exit surface 22b is the same as the included angle between the light irradiated to the second light exit surface 22b and the second light exit surface 22b, which is equivalent to that the light is reflected totally on the second light exit surface 22b.

The collimating lens 10b plays a role in adjusting the direction of the light emitted by the light source 32b, the outer side surface of the collimating lens 10b is a conical surface 12b, the conical surface 12b inclines outward, and the outer diameter of the collimating lens 10b increases gradually in a direction from the inner end to the outer end.

As shown in FIG. 5, the first light entry surface 111b protrudes towards the inner end surface of the collimating lens 10b; and an irradiating angle range of the light source 32b to the first light entry surface 111b may be 30 degrees to 90 degrees, and the incident light 14b entering the first light entry surface 111b is irradiated to the first light exit surface 21b in a direction perpendicular to the first light exit surface 21b, and continuously emit along a direction perpendicular to the first light exit surface 21b for key lighting. The light emitted from the first light exit surface 21b is first exited light 24b.

As shown in FIG. 5, the light that is emitted by the light source 32b outside the first light entry surface 111b is irradiated to the second light entry surface 112b. For example, in a case that an angle of the light emitted by the light source 32b to the first light entry surface 111b is 30 degrees, the remaining light in a total angle of 150 degrees is irradiated to the second light entry surface 112b. In a case that the angle of the light emitted by the light source 32b to the first light entry surface 111b is 90 degrees, the remaining light in a total angle of 90 degrees is irradiated to the second light entry surface 112b. The incident light 14a entering the second light entry surface 112 is irradiated to the conical surface 12b, reflected totally on the conical surface 12b so as to be irradiated to the second light exit surface 22b in a direction of forming an included angle of 45 degrees with the second light exit surface 22b, and reflected totally on the second light exit surface 22, and further emit in a direction parallel to the ceiling 40. The light reflected by the second light exit surface 22b is second exited light 25b, and the second exited light 25b is parallel to the surface of the ceiling 40, which has the advantage that compared with the case where an included angle is formed between the second exited light 25b and the surface of the ceiling 40, the second exited light 25b is parallel to the surface of the ceiling 40, so that a lightened area of the ceiling 40 can be enlarged.

The first exited light 24b is perpendicular to the second exited light 25b. Because the ground is parallel to the ceiling 40, the first exited light 24b is irradiated to the ground perpendicularly for key lighting.

The periphery of the reflector 20b is connected with a mounting cylinder 50b, the mounting cylinder 50b may be transparent, the mounting cylinder 50b may also be opaque, and the mounting cylinder 50b can be made of a light-transmitting material. As shown in FIG. 5, the reflector 20b and the mounting cylinder 50b may be integrated. The reflector 20b and the mounting cylinder 50b may also be separated, and may be assembled together through a connecting structure or a connecting member. The second exited light 25b is emitted through a side wall of the mounting cylinder 50b. Preferably, the second exited light 25b is emitted in a direction perpendicular to the mounting cylinder 50b. The outer surface of the mounting cylinder 50b is provided with a boss 51b.

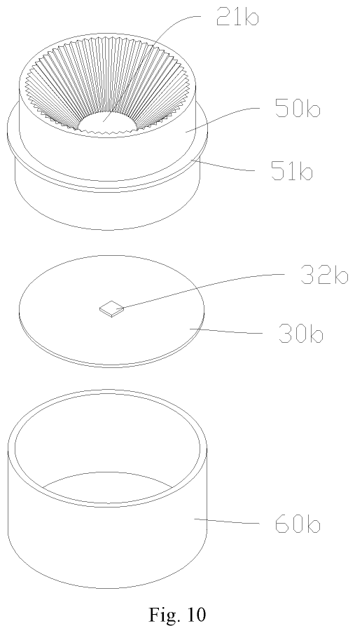

As shown in FIG. 4 and FIG. 10, the lamp further includes a shell 60b, and the shell 60b is mounted in a mounting hole of the ceiling 40. The collimating lens 10b is located in the shell 60b. The shell 60b includes a bottom plate and a side plate that are connected, and the light source substrate 31b is arranged on the inner surface of the bottom plate of the shell 60b. The shell 60b is sleeved outside the mounting cylinder 50b, and the end surface of the open end of the shell 60b is butted on the boss 51b. As shown in FIG. 5, the outer end surface of the boss 51b is butted on the inner surface of the ceiling 40, and then the second light exit surface 22b is exposed completely outside the shell 60b. The second light exit surface 22b extends beyond the ceiling 40, so that all of the second exited light 25b can be irradiated to the ceiling 40 area. The reflector 20b may be as transparent as the collimating lens 10b, and at the time, the reflector 20b and the collimating lens 10b may be integrated.

The reflector 20b may also be opaque, and then the reflector 20b and the collimating lens 10b are separated; and the reflector 20b and the collimating lens 10b are butted against each other, and the collimating lens 10b, the reflector 20b and the light source assembly 30b are assembled together through the mounting cylinder 50b and the shell 60b. The collimating lens 10b, the reflector 20b and the light source assembly 30b may also be assembled through other structural members.

The above is the preferred solution of the present example, and in other examples, the collimating lens 10b may be replaced by an ordinary lens.

In other examples, the lamp may also be a linear lamp, a wall washer lamp or other types of lamps. Both a shell and a lamp panel of the linear lamp extend along a length direction, and adaptively the shape of the light distribution element shall be adjusted as extending along the length direction.

The present disclosure provides a light distribution element, a light source module including the light distribution element and a lamp including the light source module, and the light distribution element that can improve the illumination comfort of the lamp and the light distribution element is low in cost.

A light distribution element is provided, the light distribution element includes a light entry surface, a first light exit surface and a second light exit surface, the first light exit surface is configured to receive part of light entering the light entry surface and emit the part of the light entering the light entry surface; the second light exit surface is a reflective surface, and the second light exit surface is configured to receive part of the light entering the light entry surface and reflect the part of the light entering the light entry surface; and a direction of the light emitted from the second light exit surface is different from a direction of the light emitted from the first light exit surface.

In an example of the light distribution element, the light emitted from the second light exit surface is perpendicular to the light emitted from the first light exit surface.

In an example of the light distribution element, the second light exit surface is arranged at the periphery of the first light exit surface, and the second light exit surface is inclined outward to the first light exit surface.

In an example of the light distribution element, the light distribution element comprises a collimating lens, the collimating lens is configured to allow the part of the light entering the light entry surface to be irradiated into the second light exit surface in a direction of forming an included angle of 45° with the second light exit surface.

In an example of the light distribution element, the collimating lens is configured to allow the part of the light entering the light entry surface to be irradiated into the first light exit surface in a direction perpendicular to the first light exit surface.

In an example of the light distribution element, the second light exit surface is inclined outward to the first light exit surface, and an included angle between an inclined direction of the second light exit surface and the first light exit surface is 45 degrees.

In an example of the light distribution element, the second light exit surface and the first light exit surface form a continuous surface.

In an example of the light distribution element, the light distribution element comprises a lens, an outer side surface of the lens is a conical surface inclining outward, and the conical surface is configured to receive the part of the light entering the light entry surface and reflect the light to the second light exit surface.

In an example of the light distribution element, the lens has the light entry surface, the light entry surface is recessed inward from one end surface of the lens and encloses a light source cavity, and a side surface of the light source cavity is configured to emit the light to the conical surface.

In an example of the light distribution element, a bottom surface of the light source cavity protrudes towards the end surface.

In an example of the light distribution element, the light distribution element is an integrated collimating lens.

In an example of the light distribution element, one end of the light distribution element is recessed inward from an end surface to form a light exit cavity, a bottom surface of the light exit cavity comprises the first light exit surface, and a side surface of the light exit cavity comprises the second light exit surface.

In an example of the light distribution element, the light distribution element comprises a lens and a reflector, and the lens has the light entry surface; one surface of the reflector is provided with a sawtooth, two ends of the sawtooth extend towards two ends of the reflector, and the other surface of the reflector comprises the second light exit surface.

In an example of the light distribution element, the lens and the reflector are detachably connected or integrally formed.

A light source module is provided, the light source module includes a light source and the light distribution element mentioned above, and the light entry surface is configured to receive light emitted by the light source.

A lamp is provided, the lamp includes a shell, a light source and the light distribution element mentioned above, the light entry surface is configured to receive light emitted by the light source, and the light source, the light distribution element and the shell are assembled together.

In an example of the lamp, the second light exit surface is exposed outside the shell.

In an example of the lamp, the periphery of the light distribution element is connected with a mounting cylinder, and the light reflected by the second light exit surface is emitted through a cylinder wall of the mounting cylinder.

In an example of the lamp, an outer surface of the mounting cylinder is provided with a boss, the shell is sleeved outside the mounting cylinder, and an open end of the shell is butted on the boss.

In an example of the lamp, an outer surface of the light distribution element has a step surface, the shell is sleeved outside the light distribution element, and an open end of the shell is butted on the step surface.

The light distribution element of the present disclosure has the advantages that part of light entering a light entry surface is emitted from a first light exit surface, which can be used for key lighting. The other part of light entering the light entry surface is irradiated to a second light exit surface and it can be used to illuminate the ceiling after being reflected by the second light exit surface. After the light distribution element of the present disclosure is applied to the lamp, the lamp can illuminate the ceiling area while performing the key lighting, thereby improving the illumination comfort of the whole lamp.

The present disclosure may include dedicated hardware implementations such as application specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples of the present disclosure focus on differences among the various examples. As long as different optimization features among the various examples are not contradictory, the examples can be combined to form a better example, which is not repeated here for brevity.

The above description is only examples of the present disclosure and is not used to limit the present disclosure. For those skilled in the art, various changes and variations of the present disclosure can be made. Any modifications, equivalent substitution and improvements made within the spirit and principle of the present disclosure shall be contained within the scope of the present disclosure.

What is claimed is:

1. A light distribution element, comprising a light entry surface, a first light exit surface and a second light exit surface, wherein:
the first light exit surface is configured to receive a first part of light entering the light entry surface and emit the part of the light entering the light entry surface;
the second light exit surface is a reflective surface, and the second light exit surface is configured to receive a second part of the light entering the light entry surface and reflect the part of the light entering the light entry surface; and
a direction of the light emitted from the second light exit surface is different from a direction of the light emitted from the first light exit surface.

2. The light distribution element according to claim 1, wherein the light emitted from the second light exit surface is perpendicular to the light emitted from the first light exit surface.

3. The light distribution element according to claim 1, wherein the second light exit surface is arranged at the periphery of the first light exit surface, and the second light exit surface is inclined outward to the first light exit surface.

4. The light distribution element according to claim 1, wherein the light distribution element comprises a collimating lens, the collimating lens is configured to allow the part of the light entering the light entry surface to be irradiated into the second light exit surface in a direction of forming an included angle of 45° with the second light exit surface.

5. The light distribution element according to claim 4, wherein the collimating lens is configured to allow the part of the light entering the light entry surface to be irradiated into the first light exit surface in a direction perpendicular to the first light exit surface.

6. The light distribution element according to claim 5, wherein the second light exit surface is inclined outward to the first light exit surface, and an included angle between an inclined direction of the second light exit surface and the first light exit surface is 45 degrees.

7. The light distribution element according to claim 1, wherein the second light exit surface and the first light exit surface form a continuous surface.

8. The light distribution element according to claim 1, wherein the light distribution element comprises a lens, an outer side surface of the lens is a conical surface inclining outward, and the conical surface is configured to receive the part of the light entering the light entry surface and reflect the light to the second light exit surface.

9. The light distribution element according to claim 8, wherein the lens has the light entry surface, the light entry surface is recessed inward from one end surface of the lens and encloses a light source cavity, and a side surface of the light source cavity is configured to emit the light to the conical surface.

10. The light distribution element according to claim 9, wherein a bottom surface of the light source cavity protrudes towards the end surface.

11. The light distribution element according to claim 1, wherein the light distribution element is an integrated collimating lens.

12. The light distribution element according to claim 11, wherein one end of the light distribution element is recessed inward from an end surface to form a light exit cavity, a bottom surface of the light exit cavity comprises the first light exit surface, and a side surface of the light exit cavity comprises the second light exit surface.

13. The light distribution element according to claim 1, wherein the light distribution element comprises a lens and a reflector, and the lens has the light entry surface; one surface of the reflector is provided with a sawtooth, two ends of the sawtooth extend towards two ends of the reflector, and the other surface of the reflector comprises the second light exit surface.

14. The light distribution element according to claim 13, wherein the lens and the reflector are detachably connected or integrally formed.

15. A light source module, comprising a light source and a light distribution element, wherein:
the light distribution element comprises a light entry surface, a first light exit surface and a second light exit surface;
the first light exit surface is configured to receive a first part of light entering the light entry surface and emit the part of the light entering the light entry surface;
the second light exit surface is a reflective surface, and the second light exit surface is configured to receive a second part of the light entering the light entry surface and reflect the part of the light entering the light entry surface;
a direction of the light emitted from the second light exit surface is different from a direction of the light emitted from the first light exit surface; and
the light entry surface is configured to receive light emitted by the light source.

16. A lamp, comprising a shell, a light source and a light distribution element, wherein:
the light distribution element comprises a light entry surface, a first light exit surface and a second light exit surface;
the first light exit surface is configured to receive a first part of light entering the light entry surface and emit the part of the light entering the light entry surface;
the second light exit surface is a reflective surface, and the second light exit surface is configured to receive a second part of the light entering the light entry surface and reflect the part of the light entering the light entry surface;
a direction of the light emitted from the second light exit surface is different from a direction of the light emitted from the first light exit surface; and
the light entry surface is configured to receive light emitted by the light source, and the light source, the light distribution element and the shell are assembled together.

17. The lamp according to claim 16, wherein the second light exit surface is exposed outside the shell.

18. The lamp according to claim 16, wherein the periphery of the light distribution element is connected with a mounting cylinder, and the light reflected by the second light exit surface is emitted through a cylinder wall of the mounting cylinder.

19. The lamp according to claim 18, wherein an outer surface of the mounting cylinder is provided with a boss, the shell is sleeved outside the mounting cylinder, and an open end of the shell is butted on the boss.

20. The lamp according to claim 17, wherein an outer surface of the light distribution element has a step surface, the shell is sleeved outside the light distribution element, and an open end of the shell is butted on the step surface.
